(19) United States
(12) Patent Application Publication
(10) Pub. No.: US 2012/0104863 A1
(43) Pub. Date: May 3, 2012

(54) System and Method for Combining Electrical Power from Photovoltaic Sources

(75) Inventor: Defang Yuan, Ottawa (CA)

(73) Assignee: CANADA VFD, Ottawa (CA)

(21) Appl. No.: 13/285,065

(22) Filed: Oct. 31, 2011

(30) Foreign Application Priority Data
Nov. 2, 2010 (CN) 201010530711.1

(51) Int. Cl. H02J 3/00

(52) U.S. Cl. 307/82

(57) ABSTRACT

A photovoltaic system with photovoltaic (PV) panels is described. Each of the PV panels has a corresponding inverter module. The inverter module includes a maximum power point tracker (MPPT) for independently monitoring and controlling the respective PV panel, a switch regulator for converting the DC output to an AC output; an insulating transformer for receiving the AC output and inverting the AC output at about the first voltage to a second voltage; and a rectifier for rectifying the AC output to a second DC output at about the second voltage. The photovoltaic system further includes a main inverter with two power terminals. The second DC outputs of the inverter modules are connected in parallel to the two power terminals at the second voltage, and the second DC outputs are inverted to an AC power by the main inverter.

### CROSS-REFERENCE TO RELATED APPLICATION

This application is related to and claims priority from Chinese Application Ser. No. 201010530711.1, filed on Nov. 2, 2010, entitled “System Structure and Method of Photovoltaic Sources” by Defang Yuan, the entire disclosure of which is hereby incorporated by reference for all purposes as if fully set forth herein.

### BACKGROUND OF THE INVENTION

The present invention relates to electrical power systems, and more specifically, to a system and method for combining electrical power from photovoltaic sources.

Photovoltaic (PV) or solar panels use sunlight to produce electrical energy. Each photovoltaic panel generally comprises a number of photovoltaic cells to convert the sunlight into the electrical energy. When light shines on a PV panel, a voltage develops across the cell, and a current flows through the cell when a load is connected. The majority of solar panels use wafer-based crystalline silicon cells or a thin-film cell based on cadmium telluride or silicon.

The voltage and current vary with different factors, for example but not limited to, the physical size of the PV cells, the amount of light, the temperature of the PV cells. The PV cells may be arranged in series and/or in parallel to form a PV panel. A PV panel exhibits voltage and current characteristics described by a current-voltage curve, as illustrated in FIG. 1. For each PV panel, the current decreases as the output voltage increases. At some voltage value the current approaches zero. The power output of the PV panel, which is equal to the product of current and voltage (P=I*V), varies depending on the voltage across, and current drawn from the source. At a certain current and voltage (I_{MPP}, V_{MPP}), close to the falling off point of the current, the power reaches its maximum. It is desirable to operate a power generating cell at this maximum power point. A Maximum Power Point (MPP) defines a point where the PV panels generate a maximum power. In FIG. 1, the PV panel has a specific MPP 102 with the related current and voltage values (I_{MPP}, V_{MPP}) 106, 104. In general, each PV panel has its distinct MPP.

Since PV panels generally provide low voltage output, normally about 20-60V, the PV panels need to be connected using various topologies to provide the required operating voltage. One of the commonly used topology is to connect the PV panels serially to achieve the required operating voltage.

However, current photovoltaic systems have disadvantages. Users, including professional installers, may find it difficult to verify the correct operation of the photovoltaic systems with the existing topologies. Environmental and operational factors, such as aging, collection of dust and dirt, shading, snow and module degradation affect the performance of the photovoltaic array. Serially connected PV panels may operate at sub-optimal conditions, e.g. conditions other than a condition defined by MPP, or at a high cost if the individual PV panels are controlled individually. Further, the high voltage of a PV array comprising serially connected PV panels is more difficult to handle as it may present fire or safety hazard in a residential environment and may cause early deterioration of the control modules.

Therefore, there is a need to a photovoltaic system having a low voltage on the panel to provide enhanced safety and to prevent any potential fire hazard. There is further a need to a simple topology for connecting multiple PV Panels independently to a load such as a power grid.

### SUMMARY OF THE INVENTION

According to one aspect of the invention there is provided a photovoltaic system. The photovoltaic system comprises photovoltaic (PV) panels which provide DC outputs at a first voltage; a plurality of inverter modules, each of the inverter modules is connected to a respective PV panel. The inverter module comprises a maximum power point tracker (MPPT) for independently monitoring and controlling the respective PV panel, a switch regulator for converting the DC output to an AC output; an insulating transformer for receiving the AC output and inverting the AC output at about the first voltage to a second voltage; and a rectifier for rectifying the AC output to a second DC output at about the second voltage. The photovoltaic system further comprises a main inverter receiving two power terminals. The second DC outputs of the plurality of inverter modules are connected in parallel to the two power terminals at the second voltage. The second DC outputs are inverted to an AC power by the main inverter.

In accordance with another aspect of the present invention there is provided a method of providing electrical power from photovoltaic sources. The method comprises the steps of providing DC outputs at a first voltage from a plurality of photovoltaic (PV) panels; converting each of the DC output to a respective AC output at a respective inverter module; receiving the AC output at an insulating transformer of the inverter module, inverting the AC output at about the first voltage to a second voltage; rectifying the AC output to a second DC outputs at about the second voltage; connecting in parallel the second DC outputs from the respective inverter module of the plurality of photovoltaic (PV) panels to two power terminals of a main inverter; and inverting the second DC outputs to an AC power by the main inverter; wherein the second DC outputs of the plurality of inverter modules are connected in parallel to the two power terminals at the second voltage.

In a preferred embodiment, each of the plurality of PV panels operates independently at a maximum power point (MPP).

In a preferred embodiment, each of the plurality of inverter modules is collocated with each of the PV panels.

In a preferred embodiment, each of the plurality of inverter modules is located at a centralized location.

In a preferred embodiment, each of the plurality of inverter modules is located proximate to the main inverter.

In a preferred embodiment, the AC power is for household use.

In a preferred embodiment, the AC power is fed to a power grid.

In a preferred embodiment, the plurality of PV panels have different specifications.

In a preferred embodiment, the plurality of PV panels have different sizes.

In a preferred embodiment, each of the plurality of PV panels is grounded so that a voltage anywhere on the PV panel is smaller or equal to the first voltage.

In a preferred embodiment, the insulating transformer is a high frequency transformer.

In a preferred embodiment, the second voltage is 250-820V.

In a preferred embodiment, the system provides galvanic isolation between the DC outputs and the second DC outputs.

In a preferred embodiment, the switch regulator includes a full bridge, a half bridge, or a push-pull circuit.

In a preferred embodiment, the system further comprises a microprocessor controlling an operation of the inverter module.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a current-voltage curve of a photovoltaic panel;

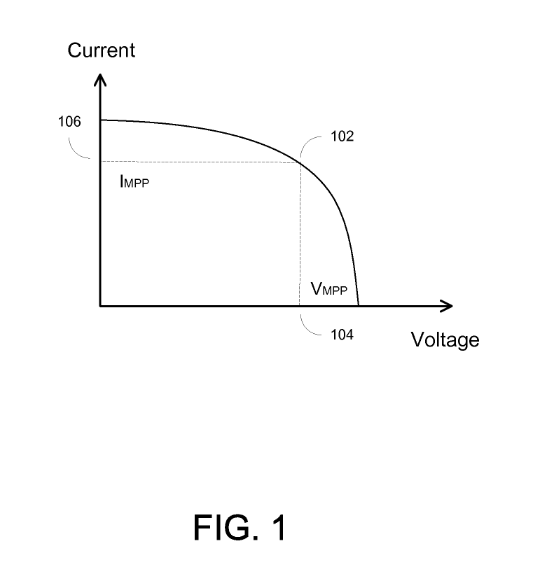

FIG. 2 illustrates an exemplary photovoltaic array comprising serially connected photovoltaic panels;

FIG. 3 illustrates another exemplary photovoltaic array comprising serially connected photovoltaic panels with individual maximum power point trackers;

FIG. 4 depicts a photovoltaic system in accordance with one embodiment of the present application;

FIG. 5 shows another embodiment in accordance of the present invention;

FIG. 6 illustrates components within the inverter module in accordance with one embodiment of the present invention; and

FIG. 7 shows a method for providing photovoltaic power in accordance with one embodiment of the present invention.

### DETAILED DESCRIPTION OF PREFERRED EMBODIMENTS

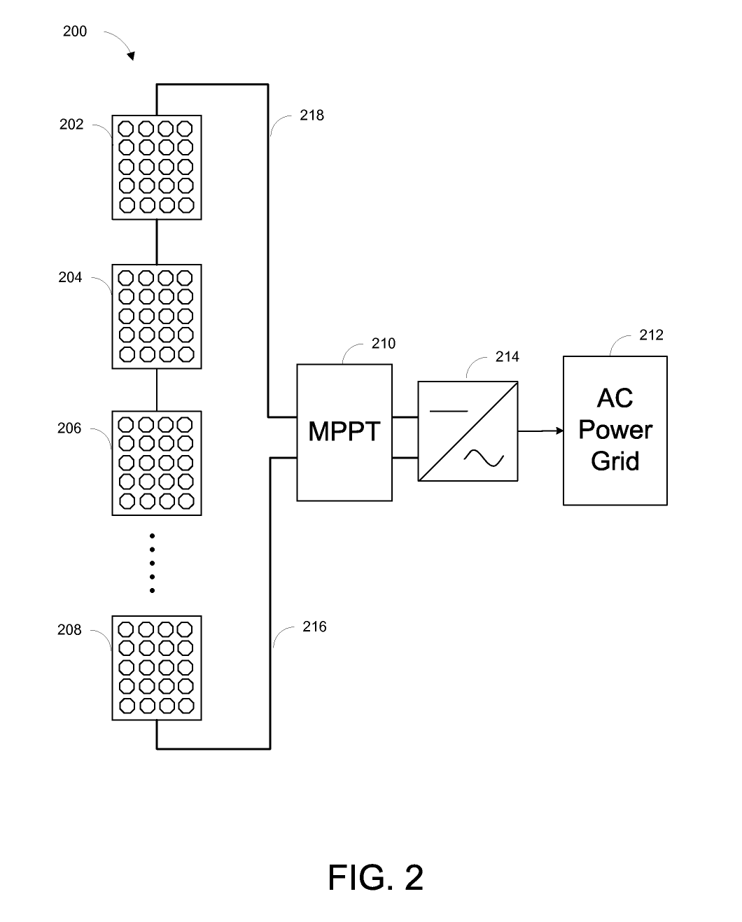

Referring to FIG. 2, a conventional photovoltaic array 200 comprising PV panels 202, 204, 206, 208 is shown. Since the voltage provided by each individual solar panel is relatively low, panels are connected in series to form the photovoltaic array 200. A photovoltaic system which supplies alternating current (AC) power to the power grid 212 may include a power conversion module, for example but not limited to, a DC-to-AC inverter, or grid transformer 214, for converting direct current (DC) power from PV array 200 into AC output power having a desired voltage and frequency, which is usually 110V or 220V at 60 Hz, or 220V at 50 Hz, to be used for operating electric appliances or supplied to an electrical grid.

In FIG. 2, the PV panels 202, 204, 206, 208 are electrically arranged in series in the PV array 200 so that the PV array 200 outputs power at the MPP when the array is operated under predetermined reference conditions for load impedance, temperature, and illumination. For example, the output voltage and output current from a PV array for converting sunlight to electricity may be chosen to deliver electrical power corresponding to the MPP for unobstructed sun exposure at a selected day of year and a selected time of the day. However, as sun changes in position relative to the PV array 200, the current output of the PV array 200 also changes, as does the MPP. Illumination received by PV panels 202, 204, 206, 208 in the PV array 200 is also affected by changes in the transmission of sunlight through the earth's atmosphere, for example by weather changes which reduce the amount of sunlight incident upon the PV array 200. Temperature changes, for example changes in ambient temperature and changes in direct solar heating of PV array components throughout the day or from season to season, also cause the power output from the PV array 200 to deviate from the MPP.

The PV array 200 may therefore include means for adjusting output voltage or output current so that power output from the PV array 200 remains close to the MPP as the MPP changes in response to changes in environmental and operating conditions. Since the PV array output voltage preferably remains within the inverter's relatively narrow DC input range, a PV array 200 equipped to adjust its output to track a changing value of MPP generally does so by adjusting the array output current. A maximum power point tracker 210 (MPPT) is generally included in the PV energy generating system, which adjusts PV array output current in response to environmental and operating conditions. An MPPT generally adjusts the impedance of an electrical load connected to the PV array 200, thereby setting the PV array 200 output current to an adjusted MPP value. The PV panels 202, 204, 206, 208 are connected in series to a single MPPT 210, the MPPT 210 must select a single point, which would be somewhat of an average of the MPP of the serially connected PV panels 202, 204, 206, 208. In practice, it is likely that the MPPT would operate at an MPP that may be only sub-optimal, i.e. off the maximum power point for PV panels 202, 204, 206, 208. Many techniques for MPPT are known to a person skilled in the art. A summary is provided by “Comparison of Photovoltaic Array Maximum Power Point Tracking Techniques” by T. Esram & P. L. Chapman, IEEE Transactions on Energy Conversion (Vol. 22, No. 2, pp. 439-449, June 2007), the entire content of which is incorporated herein by this reference. In FIG. 2, the MPPT 210 and the DC-to-AC inverter 214 are illustrated as separate entities. However, it should be apparent to a person skilled in the art that they may be collocated or manufactured as one unit.

For a PV array 200 as illustrated in FIG. 2 to achieve its highest energy yield, current practice includes carefully matching the electrical characteristics of each PV panels 202, 204, 206, 208 in the PV array 200. Matching is costly and time-consuming during manufacture at the factory or during installation. For example, various inconsistencies in manufacturing may cause two identical panels to provide different output characteristics. Similarly, two identical panels may react differently to operating and/or environmental conditions, such as load, temperature, etc. In practical installations, different panels may also experience different environmental conditions, e.g., in PV array 200 some panels may be exposed to full sun, while others may be shaded, thereby delivering different power output. Moreover, even if PV panels 202, 204, 206, 208 are ideally matched at the time of installation, degradation at a single PV panel in the PV array 200 can quickly degrade the performance, i.e., DC output, of the entire PV array 200. Decreasing the current or voltage output from a single PV panel degrades the output of the entire serially connected PV array 200. For example, if the PV panel 204 is blocked due to shading, e.g., from clouds, leaves, man-made structures, moisture, soiling, then even ideally matched PV panels 202, 206, 208 may perform poorly. Moreover, the affected PV panel 204 may suffer from excessive heating. A failure at any of the serially connected PV panels will likely lead to the non-operation of the entire array 200.

In general, the number of panels in each serially connected PV array 200 is fixed. Changing and replacing a serially configured PV panel in a PV array generally is a labor- and time-intensive process. More specifically, for the arrangement depicted in FIG. 2, a replacement panel needs to be carefully selected to match the remaining panels in an existing array.

An additional disadvantage for the serially connected array is that the high voltage at the ends of the PV array, as this may not be in compliance with the building code or regulation when used in a residential setting and improper installation may present a fire or safety hazard. For example and referring to FIG. 2, the voltage on each of the panels 202, 204, 206, 208 increases successively along the series of the PV panels, resulting in increasingly high voltages at the panels at the ends of the PV array 200, in relation to the respective terminals 216, 218. Those high voltages at the panels represent safety and fire hazards.

Various solutions have been proposed in order to overcome the aforementioned disadvantages and deficiencies of the serial installation depicted in FIG. 2.

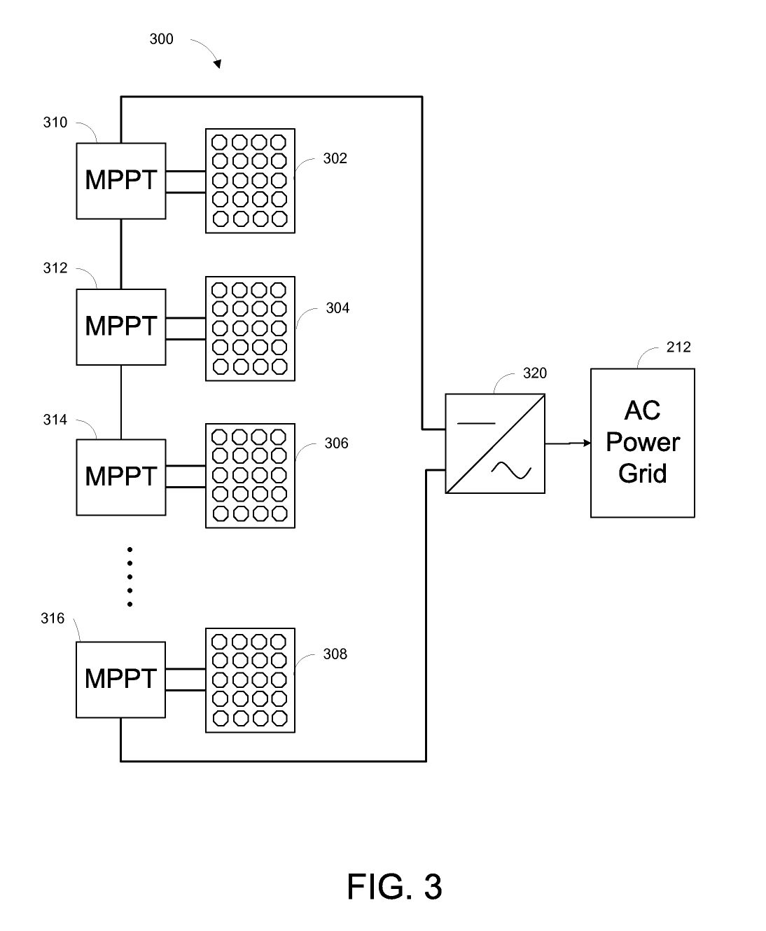

One example is described in FIG. 3. In FIG. 3, PV panels 302, 304, 306, 308 are electrically arranged in series in the PV array 300. Each of the panels 302, 304, 306, 308 is controlled by a separate MPPT 310, 312, 314, 316 operates at its optimum. Since each of the panels 302, 304, 306, 308 is controlled independently, the inefficiencies caused by suboptimal power drawn from each individual panel in the embodiment in FIG. 2 using a centralized MPPT is overcome. PV panels with different specification or from different manufacturers may be used. Likewise, if one panel is obstructed or otherwise impacted by the environmental conditions, other PV panels may still function properly and independently at or near their respective MPP.

However, incorporating MPPT 310, 312, 314, 316 into each respective PV panel 302, 304, 306, 308 may be problematic in serial application, as each MPPT 310, 312, 314, 316 would attempt to drive its respective PV panel 302, 304, 306, 308 at a different current, because in a serial connection the same current must flow through all of the PV panels in the PV array 300. Furthermore, the inherent disadvantages with serially connected array, such as high voltages at the panels, are not overcome.

For reasons such as regulatory requirements in the United States, it is prescribed to ground one of the outputs of the PV panels. Furthermore, disadvantages also arise in operation when grounding is missing. One example is the high-frequency leakage currents. Due to inevitable, parasitic capacitances between the PV panels and the ground, considerable equalizing currents creating a safety risk may occur. Moreover, PV panels with crystalline and polycrystalline cells or certain thin film modules are preferably grounded with the negative terminal during operation.

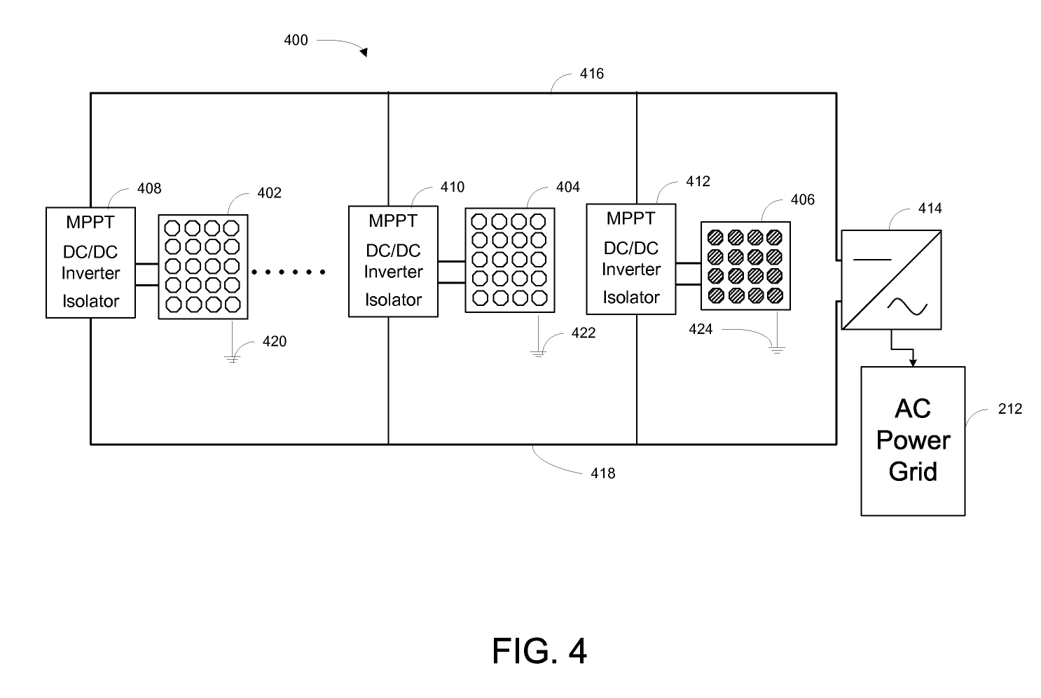

Referring to FIG. 4, in accordance with one embodiment of the present application there is provided a photovoltaic system for combining electrical power from photovoltaic sources.

The photovoltaic system 400 includes a plurality of PV panels 402, 404, 406. Each of the PV panels is connected to a inverter module 408, 410, 412. Accordingly, each of the PV panels 402, 404, 406 is controlled independently. Each of the inverter modules 408, 410, 412 comprises an MPPT and a DC/DC inverter to extract maximum possible power from each PV panel in different operational and environmental conditions. Each of the inverter modules 408, 410, 412 is connected parallel to the same DC bus terminals 416, 418 which are connected to the main inverter or grid transformer 414. In the embodiment illustrated in FIG. 4, the voltage on the DC bus terminals 416, 418 may generally be high, for example, from 250V to 820V. However, each of the PV panels remains generally under a low voltage, that is, the photovoltaic panels 402, 404, 406 are under the output voltages of the panels before a DC/DC conversion, e.g. between 20 to 60V. Advantageously, the low voltage at the panels is unlikely to present a safety or fire hazard. In one preferred embodiment, the PV panels 402, 404, 406 are grounded 420, 422, 424. In another preferred embodiment, the negative terminal of the PV panels 402, 404, 406 are grounded.

This embodiment of the present invention also provides distributed monitoring and control features, in order to react to variable operational and environmental conditions where the different PV panels 402, 404, 406 are present. If one of the PC panels, for example, panel 404, is impeded, the remaining panels 402, 406 operate normally as the PV panels are connected in parallel. Furthermore, PV panels with different specifications or from different manufactures may be used in the PV array 400. For example, PV panel 406 may have a different size and/or different numbers of photovoltaic cells than PV panels 402, 404. All PV panels may output different DC currents as the PV panels are connected in parallel to the DC bus terminals 416, 418. Panels can be added or removed without affecting the existing panels. The lower voltage on the PV panels is particularly suitable for residential environment. The lower voltage on the PV panels further means a reduced requirement for isolation material in PV panel manufacturing, thus reduced cost for the manufacturing.

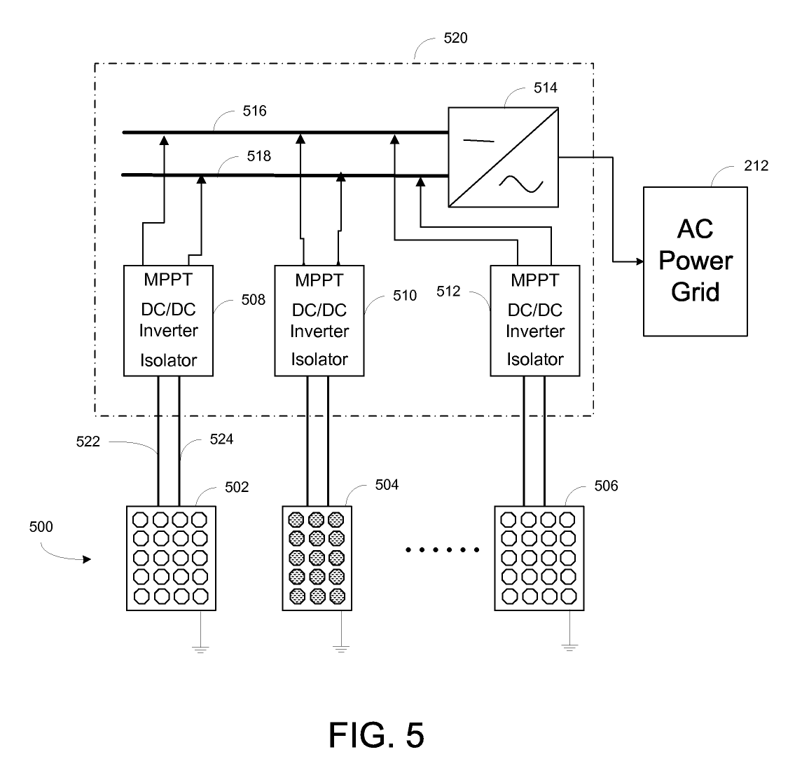

FIG. 5 shows another embodiment in accordance with the present invention. The PV panel array 500 includes a plurality of PV panels 502, 504, 506. The PV panels 502, 504, 506 are controlled individually by the MPPT and DC/DC inverter 508, 510, 512. In this embodiment, the MPPT and DC/DC isolators 508, 510, 512 are collocated or in proximity with the main inverter or grid transformer 514, likely within the same enclosure 520. The DC bus therefore includes two short terminals 516, 518 as a backbone for the inverter modules 508, 510, 512 so that the output of the inverters can be connected in parallel to the DC bus. As a result, the connections 522, 524 between the PV panels 502, 504, 506 and their respective controllers 508, 510, 512 have a lower voltage, corresponding to the output of the PV panels, e.g. between 20 to 60V.

In addition to the first embodiment as illustrated in FIG. 4, the embodiment in FIG. 5 has the additional advantage that the connections 522, 524 from the PV panels to the controllers, which are centrally located and remote from the panels, are also under lower voltage. This further enhances the safety and reduces fire risks. As with the first embodiment illustrated in FIG. 4, the parallel connected PV panels 502, 504, 506 may also have different specifications, including but not limited to, different sizes, different current output, different manufacturers, different PV panel voltage output before the DC/DC conversion, as described below.

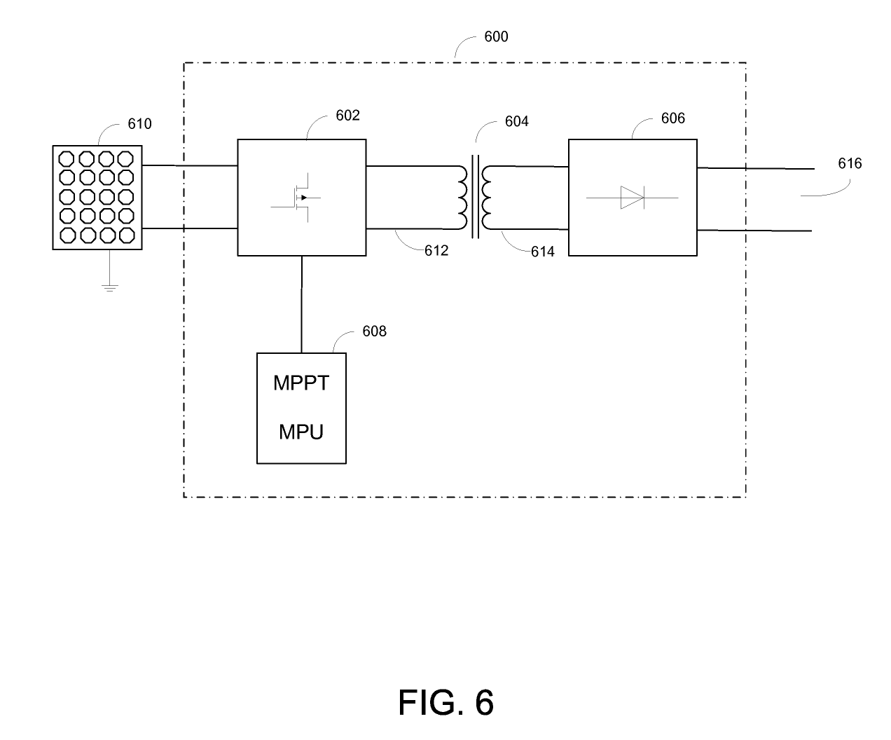

FIG. 6. illustrates components within the inverter module 408, 410, 412, 508, 510, 512. The inverter module 600 includes a switch regulator 602, an insulating transformer 604 and a rectifier 606 rectifying the output from the insulating transformer 604. The inverter module 600 may further include a controller 608 comprising MPPT and an MPU (microprocessor). The controller 608 controls the operation of the inverter module and also provides the MPPT function, i.e. track the MPP of the PV panel 610.

In a preferred embodiment, the inverter module 600 is a high-frequency insulating DC-DC inverter, and the insulating transformer 604 is a high-frequency insulating transformer which outputs a high-frequency voltage.

The switch regulator 602 is provided on the input side (primary side) 612 of the insulating transformer 604. The switch regulator 602 includes one or more switching element, such as a MOSFET (field-effect transistor) or an IGBT (insulated-gate bipolar transistor). It should be apparent to a person skilled in the art that different converter topologies may be used for the switch regulator 602, for example but not limited to: full bridge, half bridge, or push-pull. Similarly, different circuit configurations may be used for the rectifier 606, for example but not limited to: full-bridge rectifier or voltage-doubler rectifier. In one exemplary embodiment, power transistors may be implemented with IGBTs, which are commonly employed in high-power applications to generate an AC output, preferably a high frequency AC output. The AC output is provided to the input side 612 of the insulating transformer 604, and a resulting AC voltage is generated on the output side (secondary side) 614 of the transformer 604. Depending on the winding configuration of the transformer 604, the AC output provided to the input side 612 may be increased or decreased as desired. In a preferred embodiment, the AC output is increased.

In operation, the inverter module 600 converts unregulated DC input from the PV panel 610 to a regulated DC output 616. In a preferred embodiment, the voltage of the output is between 250 and 820V. The inverter module 600 provides galvanic isolation between the DC input and the DC output. The galvanic isolation prevents system grounding problems that may otherwise result.

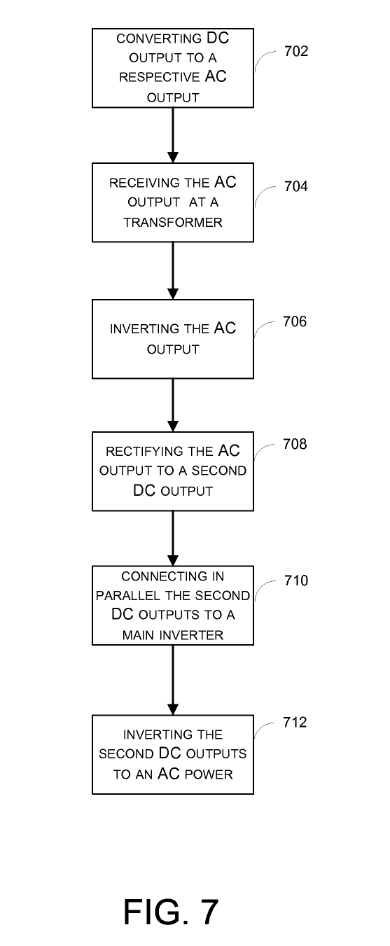

FIG. 7 shows the steps of a method for providing photovoltaic power. At 702, each of the DC output is converted to a respective AC output at a respective inverter module; at 704, the AC output is received at an insulating transformer of the inverter module; at 706, the AC output is inverted at about the first voltage to a second voltage; at 708, the AC output is rectified to a second DC output at about the second voltage; at 710, the second DC outputs are connected in parallel from the respective inverter module of the plurality of PV panels to two power terminals of a main inverter; and at 712, the second DC outputs are inverted to an AC power by the main inverter.

While the patent disclosure is described in conjunction with the specific embodiments, it will be understood that it is not intended to limit the patent disclosure to the described embodiments. On the contrary, it is intended to cover alternatives, modifications, and equivalents as may be included within the scope of the patent disclosure as defined by the appended claims. In the above description, numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

The terminology used herein is for the purpose of describing particular embodiments only and is not intended to be limiting of the patent disclosure. As used herein, the singular forms “a”, “an” and “the” are intended to include the plural forms as well, unless the context clearly indicates otherwise. It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

It is further understood that the use of relational terms such as first and second, and the like, if any, are used solely to distinguish one from another entity, item, or action without necessarily requiring or implying any actual such relationship or order between such entities, items or actions.

What is claimed is:

1. A photovoltaic system comprising:
a plurality of photovoltaic (PV) panels providing DC outputs at a first voltage;
a plurality of inverter modules, each of the inverter modules connected to a respective PV panel, each of the inverter modules comprising:
a maximum power point tracker (MPPT) for independently monitoring and controlling the respective PV panel, a switch regulator for converting the DC output to an AC output;
an insulating transformer for receiving the AC output and inverting the AC output at about the first voltage to a second voltage; and
a rectifier for rectifying the AC output to a second DC output at about the second voltage; and
a main inverter receiving two power terminals;
wherein the second DC outputs of the plurality of inverter modules are connected in parallel to the two power terminals at the second voltage,
wherein the second DC outputs are inverted to an AC power by the main inverter.

2. The photovoltaic system of claim 1, wherein each of the plurality of PV panels operates independently at a maximum power point (MPP).

3. The photovoltaic system of claim 1, wherein each of the plurality of inverter modules is collocated with each of the PV panels.

4. The photovoltaic system of claim 1, wherein each of the plurality of inverter modules is located at a centralized location.

5. The photovoltaic system of claim 1, wherein each of the plurality of inverter modules is located proximate to the main inverter.

6. The photovoltaic system of claim 1, wherein the plurality of PV panels have different specifications.

7. The photovoltaic system of claim 1, wherein the plurality of PV panels have different sizes.

8. The photovoltaic system of claim 1, wherein each of the plurality of PV panels is grounded so that a voltage anywhere on the PV panel is smaller or equal to the first voltage.

9. The photovoltaic system of claim 1, wherein the insulating transformer is a high frequency transformer.

10. The photovoltaic system of claim 1, wherein the second voltage is 250-820V.

11. The photovoltaic system of claim 1, wherein the system provides galvanic isolation between the DC outputs and the second DC outputs.

12. The photovoltaic system of claim 1, wherein the switch regulator includes a full bridge, a half bridge, or a push-pull circuit.

13. The photovoltaic system of claim 1, further comprising a microprocessor controlling an operation of the inverter module.

14. A method of providing electrical power from photovoltaic sources comprising:
providing DC outputs at a first voltage from a plurality of photovoltaic (PV) panels;
converting each of the DC output to a respective AC output at a respective inverter module;
receiving the AC output at an insulating transformer of the inverter module,
inverting the AC output at about the first voltage to a second voltage;
rectifying the AC output to a second DC outputs at about the second voltage;
connecting in parallel the second DC outputs from the respective inverter module of the plurality of photovoltaic (PV) panels to two power terminals of a main inverter; and
inverting the second DC outputs to an AC power by the main inverter;
wherein the second DC outputs of the plurality of inverter modules are connected in parallel to the two power terminals at the second voltage.

15. The method of claim 14, further comprising operating each of the plurality of PV panels independently at a maximum power point (MPP).

16. The method of claim 14, further comprising collocating each of the plurality of inverter modules with each of the PV panels.

17. The method of claim 14, further comprising grounding the plurality of PV panels.

18. The method of claim 14, wherein the AC power is fed to a power grid.

19. The method of claim 14, further comprising providing galvanic isolation between the DC outputs and the second DC outputs.

20. The method of claim 14, wherein the second voltage is 250-820V.
